(19) United States
(12) Patent Application Publication
(10) Pub. No.: US 2016/0366919 A1
(43) Pub. Date: Dec. 22, 2016

(54) SYSTEMS AND METHODS FOR PRESERVATION OF PERISHABLE SUBSTANCES

(71) Applicant: Stephen Kyle van Someren Greve, East Wenatchee, WA (US)

(72) Inventor: Stephen Kyle van Someren Greve, East Wenatchee, WA (US)

(21) Appl. No.: 15/184,792

(22) Filed: Jun. 16, 2016

Related U.S. Application Data
(60) Provisional application No. 62/180,315, filed on Jun. 16, 2015.

(51) Int. Cl. A23L 3/3409; F25D 27/00; F25D 11/02; B01D 53/22; F25D 17/04; A23L 3/3418; A21D 15/00; A23B 7/148; F25B 21/02; F25D 25/02

(52) U.S. Cl. CPC A23L 3/34095; F25B 21/02; F25D 27/005; F25D 11/02; F25D 25/025; F25D 17/042; A23L 3/3418; A21D 15/00; A23B 7/148; B01D 53/22; F25D 2700/12; A23V 2002/00; B01D 2053/221

(57) ABSTRACT

In one embodiment, a system for preserving perishable substances includes a first compartment, a second compartment, a preservation gas source, and a control system. Each of the first and second compartments has an interior portion having a volumetric capacity of less than or equal to about 35 cubic feet. The control system is configured to deliver preservation gas from the preservation gas source separately to the interior portions of each of the first and second compartments such that the interior portions of each of the first and second compartments has a gaseous environment with an oxygen level less than about 20% when the first and second compartments are in a closed position. The oxygen level in the first compartment is different from the oxygen level in the second compartment. Other system and method embodiments are described and claimed.

### CROSS-REFERENCE TO RELATED APPLICATION

This patent application claims the benefit of U.S. Provisional Application No. 62/180,315, filed Jun. 16, 2015, the disclosure of which is hereby expressly incorporated by reference in the present application.

### BACKGROUND

Many techniques and systems for preserving perishable materials have been developed. For example, refrigerators have compressor driven cooling mechanisms to cool areas for preservation of perishable materials, such as foodstuffs. Other techniques and systems use vacuum sealing packaging where gasses are removed from a package and then a perishable material is sealed inside the package with a minimal amount of gas inside the package.

Some preservation systems, such as commercial food packers, use sophisticated preservation systems built into large facilities (e.g., food packing plants) or vehicles. Such systems include controlled atmosphere rooms where levels of oxygen, nitrogen, and other gasses are controlled and monitored to help preserve perishable materials. In these large preservation systems, components of the systems are built into the structure of the facility (e.g., packaging and storage facilities) and may monitor levels of gas components in rooms of the facility and make adjustments to the environment inside these rooms. Maintaining the desired environmental conditions on such a large scale can be expensive. Moreover, working in low-oxygen environments for preserving foodstuffs can be harmful to humans.

There are also systems for creating modified atmosphere packaging where the sealed packaging contains controlled levels of chemical compounds. However, it is difficult to maintain the controlled levels of chemical compounds after the sealed packaging has been opened.

Therefore, there exists a need for improved systems and methods for the preservation of perishable substances. Embodiments of the present disclosure are directed to fulfilling this and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a system for preserving perishable substances is provided. The system includes: a first compartment and a second compartment, wherein each of the first and second compartments has an interior portion having a volumetric capacity of less than or equal to about 35 cubic feet; a preservation gas delivery system; and a control system configured to deliver preservation gas from the preservation gas source separately to the interior portions of each of the first and second compartments such that the interior portions of each of the first and second compartments has a gaseous environment with an oxygen level less than about 20% when the first and second compartments are in a closed position, wherein the oxygen level in the first compartment is different from the oxygen level in the second compartment.

In accordance with another embodiment of the present disclosure, a system for preserving perishable substances is provided. The system includes: a compartment having an interior portion; a preservation gas generation system configured to provide a preservation gas, the preservation gas generation system comprising at least one of a preservation gas separation membrane configured to separate a preservation gas from ambient air or a preservation gas generator configured to generate the preservation gas from chemical or physical reactions; a control system configured to selectively deliver the preservation gas from the preservation gas generation system to the interior portion of the compartment such that the interior portion of the compartment has a gaseous environment with an oxygen level less than about 20% when the compartment is in a closed position; and a housing configured to contain the compartment, the preservation gas separation membrane, and the control system.

In accordance with another embodiment of the present disclosure, a method of maintaining an environment for preserving perishable substances within a compartment, wherein the compartment has as interior portion, and wherein the compartment is capable of being moved between an open position and a closed position, is provided. The method includes: detecting that the compartment is in a closed position; and delivering a preservation gas to the interior portion of the compartment in response to detecting that the compartment has been moved to the closed position, wherein delivering the preservation gas causes an oxygen content of a gaseous environment in the interior portion of the compartment to be less than about 20%.

In any of the embodiments described herein, the system further may include a housing configured to contain the first and second compartments, the preservation gas delivery system, and the control system.

In any of the embodiments described herein, the system may further include a temperature control system configured to selectively change the temperature within at least one of the first and second compartments.

In any of the embodiments described herein, the system may further include an input device configured to receive an input indicative of a substance to be contained in one of the first and second compartments or by an input indicative of a storage method to be executed.

In any of the embodiments described herein, the control system may be further configured to deliver the preservation gas to the one of the first and second compartments based on the substance to be contained in the one of the first and second compartments or the storage method to be executed.

In any of the embodiments described herein, the input device may be configured to receive the input by at least one of receiving a user-entered input or reading an inventory tracking system label.

In any of the embodiments described herein, at least one of the first and second compartments may include a transparent portion configured to make at least a portion of the interior portion viewable from an external viewer when the one of the first and second compartments is in the closed position.

In any of the embodiments described herein, the preservation gas delivery system may include a preservation gas generation system configured to provide a preservation gas to at least one of the first and second compartments.

In any of the embodiments described herein, the preservation gas generation system may include at least one of a preservation gas separation membrane configured to separate a preservation gas from ambient air, a preservation gas generator configured to generate the preservation gas from chemical or physical reactions, and a preservation gas supply tank.

In any of the embodiments described herein, the preservation gas generation system may include a preservation gas separation membrane, and wherein the preservation gas generation system further includes an air control system configured to control one or more of temperature, pressure, filtering, and flow rate of the ambient air to the preservation gas separation membrane.

In any of the embodiments described herein, the preservation gas generation system may include one or more of a nitrogen membrane configured to separate nitrogen from the ambient air, an argon membrane configured to separate argon from the ambient air, or a carbon dioxide generator configured to generate carbon dioxide from a chemical or physical reaction.

In any of the embodiments described herein, the system may further include at least one sensor configured to generate a signal indicative of at least one characteristic within the interior portion of the compartment.

In any of the embodiments described herein, the preservation gas delivery system may be configurable to deliver preservation gas to an external source.

In any of the embodiments described herein, the system may further include a preservation gas tank configured to store the preservation gas separated from the ambient air by the preservation gas separation membrane, wherein the control system is configured to selectively deliver the separated preservation gas from the preservation gas tank to the interior portion of the compartment.

In any of the embodiments described herein, the system may further include an air control system configured to control one or more of temperature, pressure, filtering, and flow rate of the ambient air to the preservation gas separation membrane.

In any of the embodiments described herein, the control system may be configured to deliver the separated preservation gas to the interior portion of the compartment based on the at least one characteristic within the interior portion of the compartment.

In any of the embodiments described herein, at least one sensor may include one or more of a temperature sensor configured to generate a signal indicative of temperature within the interior portion of the compartment, a humidity sensor configured to generate a signal indicative of humidity within the interior portion of the compartment, or a chemical sensor configured to generate a signal indicative of a chemical composition within the interior portion of the compartment.

In any of the embodiments described herein, the housing may have a volumetric capacity of less than or equal to about 50 cubic feet.

In any of the embodiments described herein, the preservation gas delivery system may be configurable to deliver preservation gas to an external source.

In any of the embodiments described herein, the compartment may have been moved from an open position to a closed position.

In any of the embodiments described herein, delivering the preservation gas may include delivering the preservation gas to the interior portion of the compartment for a period of time after detecting that the compartment has been moved to the closed position.

In any of the embodiments described herein, delivering the preservation gas may include delivering the preservation gas to the interior portion of the compartment in response to feedback from at least one sensing device within the compartment.

In any of the embodiments described herein, at least one sensing device may include one or more of a temperature sensor configured to generate a signal indicative of temperature within the interior portion of the compartment, a humidity sensor configured to generate a signal indicative of humidity within the interior portion of the compartment, or a chemical sensor configured to generate a signal indicative of a chemical composition within the interior portion of the compartment.

In any of the embodiments described herein, a method may further include separating the preservation gas from ambient air using a preservation gas separation membrane.

In any of the embodiments described herein, a method may further include controlling one or more of a temperature, a pressure, filtering, or a flow rate of the ambient air in the preservation gas separation membrane.

In any of the embodiments described herein, the interior portion of the compartment may have a volumetric capacity of less than or equal to about 5 cubic feet.

### DESCRIPTION OF THE DRAWINGS

The foregoing aspects and many of the attendant advantages of the disclosed subject matter will become more readily appreciated by reference to the following detailed description, when taken in conjunction with the accompanying drawings, wherein:

FIG. 1 illustrates a perspective view of an example system for preserving perishable materials and having one or more compartments in accordance with one or more embodiments of the present disclosure;

FIG. 2 illustrates a perspective view of an example embodiment of the components of the system of FIG. 1 and how the components fit within housing, in accordance with one or more embodiments of the present disclosure;

FIG. 3 illustrates an exploded view of an exemplary compartment, including the compartment, the lighting, and the gas delivery mechanism for the system of FIG. 1, in accordance with one or more embodiments of the present disclosure;

FIG. 4 illustrates an example process flow for an example preservation gas subsystem in accordance with one or more embodiments of the present disclosure;

FIGS. 5A, 5B, and 5C illustrate example control subroutines in accordance with one or more embodiments of the present disclosure; and

FIG. 6 illustrates a block diagram of an example system for preserving perishable substances in accordance with one or more embodiments of the present disclosure;

FIG. 7 illustrates a perspective view of an example system for preserving perishable materials and having one or more compartments in accordance with one or more other embodiments of the present disclosure;

FIG. 8 illustrates a rear perspective view of the system of FIG. 7;

FIG. 9 illustrates a rear perspective view of the system of FIG. 7 with the housing removed to illustrate internal components;

FIG. 10 illustrates an exploded view of an isolated depiction of an example cooling system in the system of FIG. 7;

FIG. 11 illustrates an isolated depiction of an example a preservation gas system in the system of FIG. 7;

FIG. 12 illustrates an exploded view of an exemplary portion of the top portion of a compartment in accordance with one embodiment of the present disclosure;

FIG. 13 illustrates an example process flow for an example system for preserving perishable substances in accordance with the system of FIG. 7;

FIGS. 14A, 14B, and 14C illustrate example control subroutines in accordance with the system of FIG. 7; and

FIG. 15 illustrates a block diagram of an example system for preserving perishable substances in accordance with the system of FIG. 7.

### DETAILED DESCRIPTION

Disclosed herein are preservation systems for facilitating preservation of perishable substances (e.g., organic substances) that can be used, for example, on the scale of a home, a professional kitchen, or retail establishment. The preservation systems maintain an environment in a compartment with an oxygen level of less than about 20% (the approximate oxygen content in air) by delivering a preservation gas to an interior of the one or more compartments when the compartment is in a closed position. In some embodiments, the system compartment includes a plurality of compartments having different environments from each other. In some embodiments, the preservation gas is obtained from a preservation gas source, such as a preservation gas tank and/or preservation gas generation system (e.g., a preservation gas separation membrane). Having a lower oxygen level in the interior of the compartment than in ambient air reduces the rate of decay of a perishable substances located in the interior of the compartment.

Also disclosed herein are methods for maintaining an environment for preserving perishable substances (e.g., organic substances) within a compartment that includes detecting that a compartment has been moved to a closed position and delivering a preservation gas to the interior portion of the compartment in response to detecting that the compartment has been moved to the closed position. Delivering the preservation gas causes an oxygen content of a gaseous environment in the interior portion of the compartment to be less than about 20%.

In one embodiment, the preservation gas includes at least one gas separated from ambient air using a preservation gas separation membrane contained in the same housing as the compartment. In one example, the preservation gas includes nitrogen and the preservation gas separation membrane is a nitrogen membrane. In another example, the preservation gas includes carbon dioxide and the preservation gas separation membrane is a carbon dioxide membrane. In another example, the preservation gas includes argon and the preservation gas separation membrane is an argon membrane.

In another embodiment, the system includes a temperature control system configured to change the temperature within the compartment. Maintaining a cooler temperature in the interior of the compartment than the temperature of ambient air may reduce the rate of decay of some perishable substance of the interior of the compartment. In other embodiments, it may be desirable to increase the temperature in the interior of a compartment as compared to ambient temperature in colder climates. In one example, the temperature control system includes one or more thermoelectric coolers.

In another embodiment, the system includes a control system that controls delivery of the preservation gas to the compartment. In one example, the control system also controls one or more of a level of oxygen in the interior of the compartment, a level of humidity in the interior of the compartment, a temperature in the interior of the compartment, and the like. In some embodiments, the system is configured to receive user inputs indicative of desired levels of characteristics controllable by the control system. In other embodiments, the system is configured to receive a user input and/or read an inventory control system label (e.g., barcode, RFID sticker, or NFC tag) indicative of a substance to be contained in the compartment or a storage method to be executed, where the control system is configured to control characteristics of the environment in the compartment based on the substance to be contained in the compartment or the storage method to be executed.

Various embodiments of the preservation system may or may not include some or all of the features described herein. The illustrations and description are merely provided to explain one or more parts of particular embodiments; however, preservation systems may be embodied in many different forms and should not be construed as limited to the specific embodiments described herein.

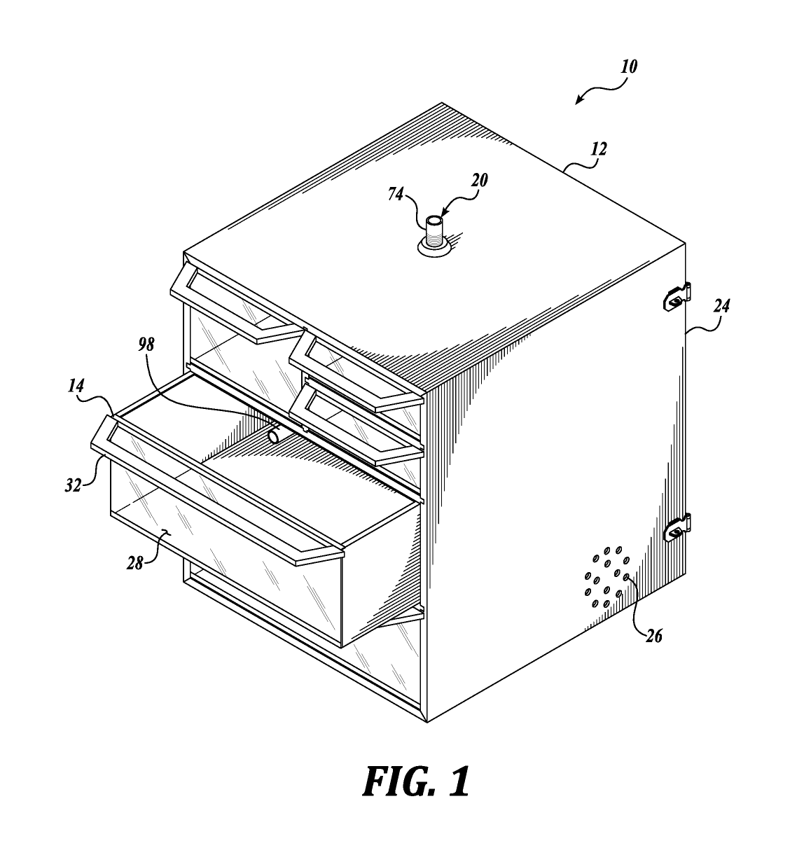

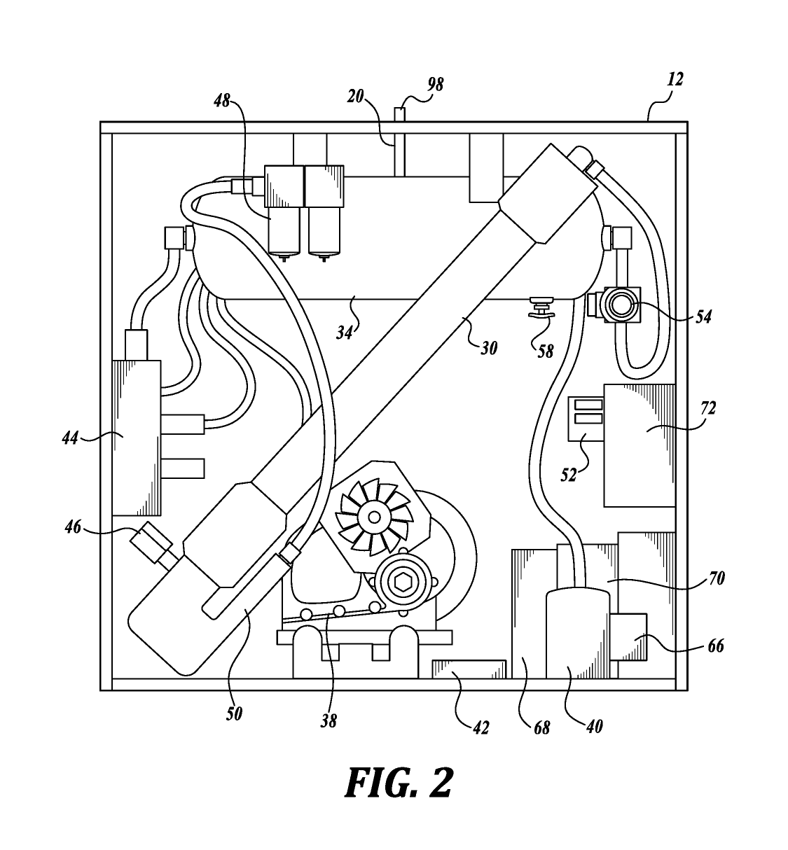

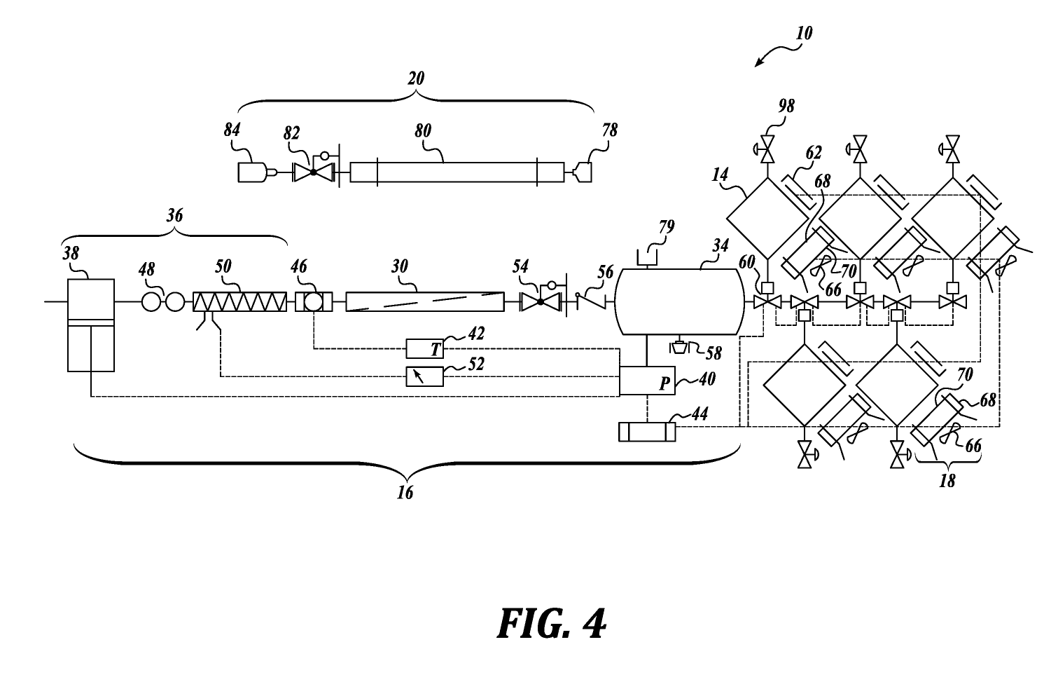

FIG. 1 depicts a perspective view of an embodiment of a system 10 for preserving perishable substances. The system 10 includes a housing 12, such as a cabinet, that contains various components, including at least one compartment 14. In the illustrated embodiment of FIG. 1, the system 10 includes a plurality of compartments 14. The system 10 described herein provides temperature and/or gas composition control for the one or more compartments 14. As described in greater detail below, the system 10 may include a preservation gas delivery system 16 (see FIGS. 2 and 4), such as a preservation gas source, and a temperature control system 18. In addition, the system 10 may include an external gas delivery system 20.

The housing 12 may be made from metal, such as aluminum or stainless steel, or from a polymer or plastic, and may include an insulation layer, such as a layer of polyurethane foam.

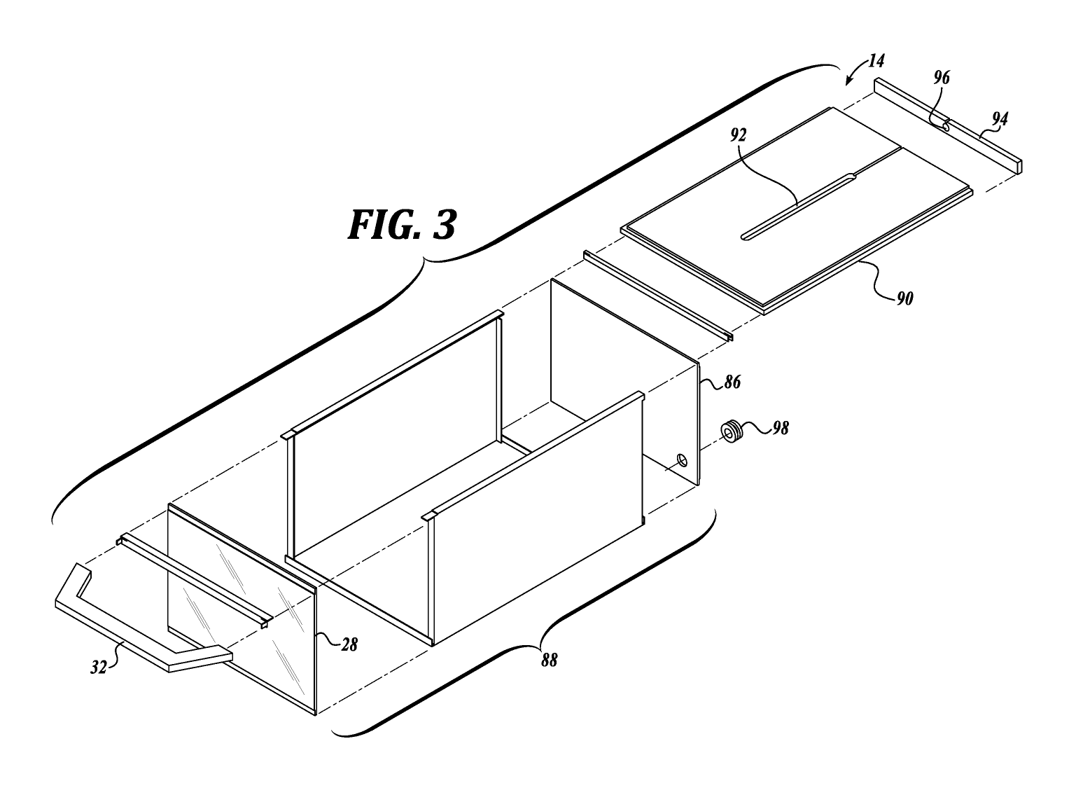

In the depicted embodiment, the compartment 14 includes a windowed portion that allows an external viewer to see the interior of the compartment 14 (see also exploded view of compartment 14 in FIG. 3). In other embodiment, compartment 14 may not have a windowed portion. The compartment 14 is designed and configured to provide adequate storage space for a user. The compartments 14 may be constructed from any suitable materials, including but not limited to stainless steel, aluminum, and suitable polymers and plastics (such as HDPE). The windowed portion 68 of the compartment 14 may be constructed from any suitable materials, including but not limited to as plexi-glass, tempered glass, and suitable polymers and plastics. The compartments 14 may be assembled using suitable assembly techniques including welding, riveting, other fasteners, adhesives, mechanical interlocking configurations, and interference fit.

In one embodiment of the present disclosure, the compartment 14 may be a drawer or another type of compartment 14 capable of being configured in open and closed positions. The position of the compartment 14 in FIG. 1 is an open position. The compartment 14 is capable of being moved to a closed position. In one embodiment, the closing of the compartment 14 forms a seal of the compartment 14 to maintain a preservation environment in the compartment 14. In another embodiment, a compartment in the housing 12 is in the form of a cabinet with one or more doors or compartments which open and close between the open position and the closed position. An exploded view of a compartment is provided in FIG. 3, as described in greater detail below.

In the illustrated embodiment shown in FIG. 1, the housing 12 includes an access door 24 that is capable of being opened to permit access to components of the system that are not contained in the compartment 14 or the other compartments in the system. While the particular embodiment of the access door 24 shown in FIG. 1 is a rear-facing door, other embodiments include access doors facing in other directions, such as a front-facing access door. In other embodiments, the housing may not include an access door.

The housing 12 optionally includes vent holes 26 on surface of the housing that permit cooling of system components contained within the housing 12. In the illustrated embodiment, the vent holes 26 are on sides of the housing 12. However, they may be positioned on other housing surfaces, such as a back, top, or front surface. In other embodiments, a heat sink or cooling fins are used in place of the vent holes 14 to permit cooling of system heat-generating components contained within the housing 12.

In one embodiment, the interior of the compartment 14 has a volumetric capacity less than or equal to about 35 cubic feet. In another embodiment, the housing 12 includes multiple compartments, the interiors of which are each less than or equal to about 35 cubic feet. In another embodiment, the housing 12 includes multiple compartments, the interiors of which are each less than or equal to about 5 cubic feet. In another embodiment, the housing 12 has a volumetric capacity of less than or equal to about 50 cubic feet. Such volumetric sizes permit the system 10 to be used on the scale of, for example, a home, a professional kitchen, or retail establishment.

Suitable placement of the system 10 may be under counter, on the counter-top, or in a standing position (for example, like a refrigerator). For the counter top application, the system may have a volumetric capacity of less than 5 cubic feet.

FIG. 2 depicts a rear view of the system 10 depicted in FIG. 1 with the rear-facing access door 24 (shown in FIG. 1) removed. The depiction in FIG. 2 provides an example of components of an embodiment of a system 10 for preserving perishable substances. The depiction in FIG. 4 provides a schematic view of some of the components depicted in FIG. 2.

In the depicted embodiment of FIG. 4, the system 10 includes a preservation gas delivery system 16 shown as a preservation gas generating system including a preservation gas separation membrane 30 and an optional preservation gas reserve tank 34. The preservation gas separation membrane 30 is configured to separate a preservation gas (e.g., nitrogen, carbon dioxide, or argon) from ambient air. Suitable preservation gas separation membranes for use in exemplary systems in accordance with embodiments of the present disclosure may include the Prism PA 1020-N1-2A-00 nitrogen membrane separator and other suitable nitrogen membrane separators.

The preservation gas reserve tank 34 is configured to store the preservation gas separated from the ambient air by the preservation gas separation membrane 30. In one exemplary embodiment, the preservation gas reserve tank 34 may have a volumetric capacity of about 5 gallons.

In other embodiments, the preservation gas delivery system 16 may include a replaceable or refillable preservation gas tank instead of or in addition to a preservation gas generation system such as the preservation gas separation membrane 30 and the preservation gas reserve tank 34 depicted in FIG. 4. A user obtains the replaceable preservation gas tank containing pressurized preservation gas and couples the replaceable preservation gas tank to the system. When the pressurized preservation gas is depleted from the replaceable or refillable preservation gas tank, the user may refill the replaceable preservation gas tank or replace the replaceable preservation gas tank with a new replaceable preservation gas tank that is pressurized with the preservation gas.

In other embodiments, the preservation gas delivery system 16 may include a preservation gas generation system including a gas generator configured to generate a preservation gas from a chemical or physical reaction. In one example, the preservation gas generation system includes a carbon dioxide generator configured to generate carbon dioxide from a chemical or physical reaction, such as the burning of natural gas, yeast byproduct, dry ice melting, or any other carbon dioxide generation method.

Referring back to the embodiment depicted in FIG. 4, the preservation gas delivery system 16 of the illustrated embodiment includes additional components beyond the preservation gas separation membrane 30 and the preservation gas reserve tank 34. For example, the preservation gas delivery system 16 may include an air control system 36 including a compressor 38 configured to provide ambient air to the preservation gas separation membrane 30 and to maintain a pressure of preservation gas in the preservation gas reserve tank 34.

In one embodiment, the compressor 38 is controlled by a controller 44, for example, using a pressure relay 40 or another independent controller. In the depicted embodiment, the pressure relay 40 detects a drop in pressure in the preservation gas reserve tank 34 below a threshold and, in response to detecting the drop in pressure, powers the compressor 38. In another embodiment, the pressure relay 40 sends a signal to a timer 42 to control a blow off valve 46. In another embodiment, the pressure relay 40 sends a signal to a controller 44 such that the controller 44 does not vent the preservation gas reserve tank 34 to the compartments 14, for example, while the tank 34 is being refilled or when the compartments 14 are in the open position. A proportional-integral-derivative (PID) controller 52 may control a solid state relay regulating power to a heater 50 warming the compressed air entering the membrane 30 or exiting the blow off valve 46.

The air control system 36 may also be configured to control one or more of temperature, pressure, or flow rate of the ambient air to the preservation gas separation membrane 30. Controlling one or more of temperature, pressure, or flow rate of the ambient air to the preservation gas separation membrane 30 may improve the concentration of preservation gas thereby improving the efficiency of the preservation gas separation membrane 30 and reducing the amount of time and/or energy to run the compressor 38.

In one embodiment, the input air control system 36 includes an air filter 48 configured to filter the ambient air (e.g., remove particles, contaminants, and moisture) prior to the ambient air entering the compressor 38.

In another embodiment, the input air control system 36 includes an air heater 50 configured to warm the compressed air before it enters the preservation gas separation membrane 30 for improving membrane efficiency.

In another embodiment, the air control system 36 includes a controller 52, such as a proportional-integrated-derivative (PID) control, configured to control the air heater 50 to maintain the ambient air in an appropriate temperature range and to control the blow off valve 46 between the heater 50 and the preservation gas separation membrane 30. The controller 52 ensures that ambient air does not enter the preservation gas separation membrane 30 before the air heater 50 reaches a desired temperature. When the timer 42 controlling the blow off valve 46 reaches its limit, the blow off valve 46 closes to redirect the ambient air into the preservation gas separation membrane 30.

In one embodiment, the preservation gas separation membrane 30 separates nitrogen from the ambient air passing through the membrane. The amount of nitrogen separated by the preservation gas separation membrane 30 depends on one or more factors, such as the flow rate, the pressure, and the temperature of the compressed air passing through it. In one embodiment, a series of pressure control valves 54 and a check valve 56 enable control of the oxygen level and keep the separated preservation gas in the preservation gas reserve tank 34. In one embodiment, the preservation gas reserve tank 34 includes a drain valve 58 configured to drain the preservation gas reserve tank 34. The drain valve 58 can be used to drain trapped liquids inside the tank 34. A safety blow off valve can be used to ensure that pressure within the preservation gas reserve tank 34 does not exceed an upper threshold.

In the depicted embodiment, the controller 44 is connected to the preservation gas reserve tank 34 and is configured to direct pressurized preservation gas via solenoids 60 into the compartment 14. In one example, the controller 44 directs pressurized preservation gas into the compartment 14 at various intervals so as to maintain a gaseous environment in the interior of the compartment 14. The solenoids 60 are operated by the controller 44 which reads the status of compartments in the housing 12, including compartment 14, through a series of compartment sensors 62, such as tactile switches or other sensors to ensure that compartments are not vented with preservation gas when in an open position and to ensure that compartments are vented appropriately in response to the compartments having been moved to a closed position.

In the depicted embodiment, the system 10 includes a temperature control system 18. The temperature control system 18 includes a fan 66, one or more thermoelectric coolers 68, and a heat sink 70. The one or more thermoelectric coolers 68 use the heat sink 70 and the fan 66 and are powered by a main power supply 72 (see FIG. 2). In one embodiment, the power supply 72 includes a solid state relay operated by PID controller 44. The PID controller 44 is configured to control the power provided to the temperature control system 18 based on signals from thermocouple sensors to maintain a specific set temperature in the compartment 14 and/or any other compartment in the housing 12.

In the illustrated embodiment of FIGS. 1 and 4, the system 34 includes an external gas delivery system 20. The external gas delivery system 20 includes an external port 74 for preservation gas. The external port 74 in the illustrated embodiment is shown as a sealing locking adaptor configured to permit external access to the preservation gas in the preservation gas reserve tank 34. The external port 74 is connectable to an external hose 80 for the external gas system shown in FIG. 4. The hose 80 includes an adjustable pressure valve 82 and a locking valve 84 that enables pressurized preservation gas to flow from the preservation gas reserve tank 34 to an external container (not shown) to displace oxygen and/or other atmospheric gases.

In one embodiment, the external port 74 may be a one-way valve attached to the housing 12 and/or the preservation gas reserve tank 34. The hose 80 illustrated in FIG. 4 relies on a sealing locking adaptor on the external port 74 of the preservation gas reserve tank 34 and a mating connector 78 to interface with the connector 79 on the preservation gas reserve tank 34.

In another embodiment, the external port 74 may be used as an access point to supply preservation gas to the preservation gas reserve tank 34 from an external source.

An exploded view of one embodiment of a compartment 14 is illustrated in FIG. 3. While the compartment 14 depicted in FIG. 3 is in the form of a drawer, the compartment may take other forms, such as a cabinet with a swinging door or doors. In the depicted embodiment, the compartment 14 includes a body portion 88 and a top portion 90. The top portion 90 may form an upper shelf in the system 10. The top portion 90 includes a recess 92 for receiving compartment lighting (not shown) configured to light the interior of the compartment.

A backstop 94 attached to the top portion 90 includes a preservation gas inlet 96. The gas inlet 96 allows preservation gas to enter the compartment from the preservation gas sources (e.g., from the preservation gas reserve tank 34 when a solenoid 60 is actuated, see FIG. 4).

The body portion 88 is suspended from the top portion 90 to create a seal and reduce gas exchange between the compartment 14 and the external environment when the compartment 14 is in its closed position. In general, gas exchange is from the compartment 14 to the external environment through a one-way valve because the compartment 14 is typically at a higher pressure than the external environment.

In the illustrated embodiment of FIG. 3, a one-way exit outlet valve 98 is located on a back wall 86 of the compartment 14. In the illustrated embodiment, the one-way outlet valve 98 may be a check valve, including a spring operated manifold and a rubber seal. Gasses are permitted to pass from the interior of the compartment 14 through the exit outlet valve 98 when forced out by preservation gas introduced through the gas inlet 96.

A transparent window 28 is provided into the compartment 14 such that an external viewer can see the contents of the compartment without opening the compartment and disrupting the environment inside. The ability of an external viewer to view the interior of the compartment without opening the compartment may decrease the number of times that the environment in the interior of the compartment needs to be filled with preservation gas. In other embodiments, doors or other sealing mechanisms may be used. A handle 32 is provided to open and close the compartment 14.

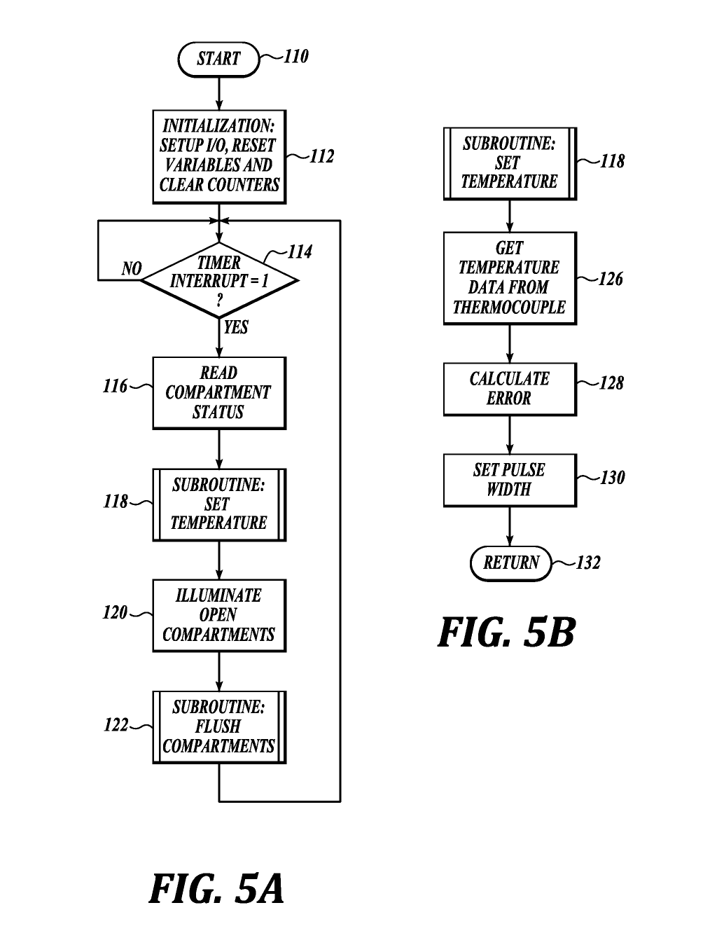

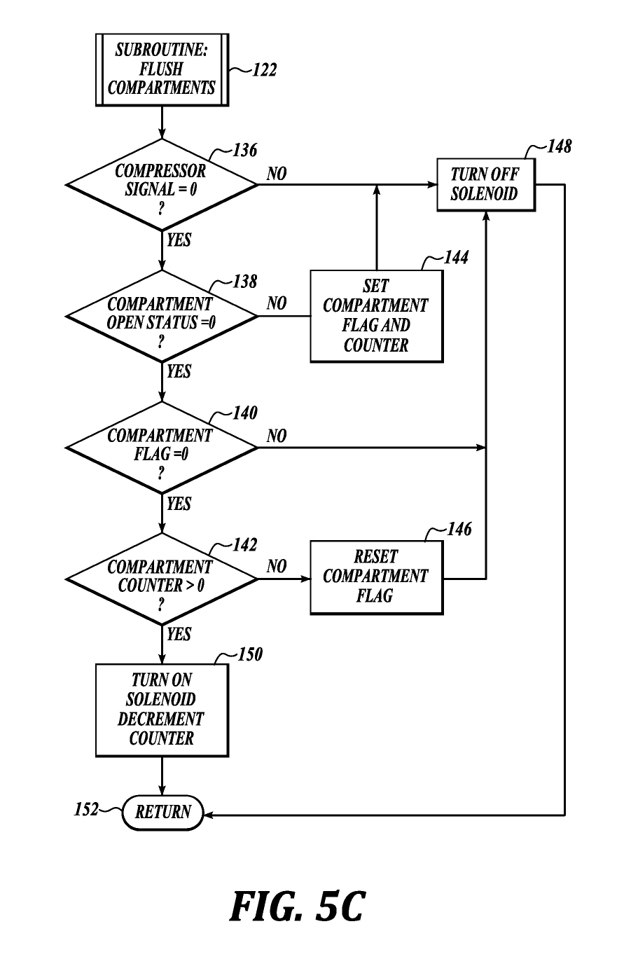

In one embodiment, the controller 44 illustrated in FIG. 4 is capable of executing a program to perform a method depicted in FIGS. 5A, 5B, and 5C. The method depicted in FIGS. 5A, 5B, and 5C includes a main routine 110 (FIG. 5A) and two subroutines: set temperature 124 (FIG. 5B), and flush compartments 134 (FIG. 5C).

Referring to FIG. 5A, the main routine 110 initializes 112 I/O variables and counters. In one embodiment, the initialization 112 occurs on power up before entering a control loop. The control loop begins by waiting 114 for a timing signal to ensure consistent execution time. After the timing signal is received, the controller reads 116 a compartment status. In one embodiment, reading 116 the compartment status includes consulting tactile switches to determine a change in compartment status (e.g., a change from an open position to a closed position). The controller executes 118 the set temperature subroutine 124 (see FIG. 5B).

Referring to FIG. 5B, the set temperature subroutine 124 first obtains 126 temperature data from one or more temperature sensors, such as a thermocouple. The controller then calculates 128 an error. In one embodiment, the error is calculated 128 based on PID principles. The controller then sets 120 a solid state relay pulse width. The controller returns 122 to the main program and illuminates 120 the compartment based on the compartment status read earlier. The controller then executes 122 the flush compartment subroutine 134 (see FIG. 5C).

Referring to FIG. 5C, in the flush compartments 134 subroutine, the controller consults 136 the compressor signal to determine if the signal is present. If the signal is not present, the controller turns off 148 the solenoids. If the signal is present, the controller consults 138 the compartment status generated earlier in the main program. If the compartment status indicates that any of the compartments is open, the controller sets 144 a flag and resets a counter, and then turns off 148 the solenoids. If the compartment status indicates that the compartments are closed, the controller consults 140 the compartments flag registry and consults 142 the compartment counter to see if any compartments have yet to be flushed. If no compartments have yet to be flushed, then the controller resets 146 the compartment flag and turns off 148 the solenoids. If compartments have yet to be flushed, the controller turns on 150 the solenoid and decrements the counter before returning 152 to the main program.

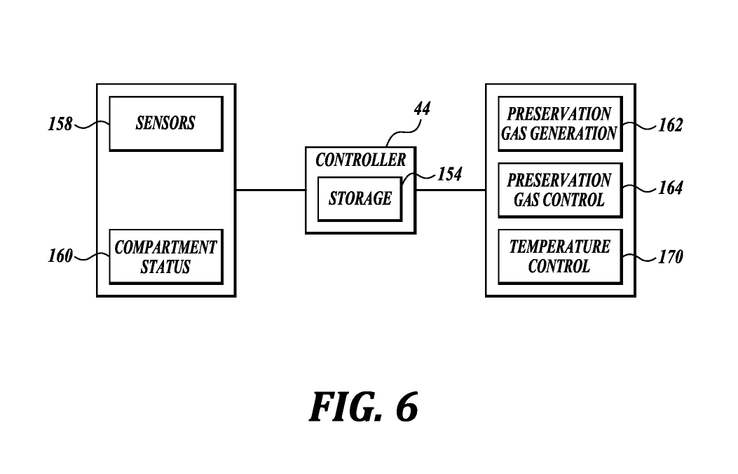

An example controller 44 capable of performing the method depicted in FIGS. 5A, 5B, and 5C is depicted in FIG. 6. The controller 44 includes storage 154 (e.g., a computer-readable medium) configured to store instructions executable by the controller 44. In one example, the storage 154 includes instructions that, in response to execution by the controller 44, cause the controller 44 to perform the method depicted in FIGS. 5A, 5B, and 5C.

In another example, the storage 154 is also configured to store preservation gas composition data and corresponding perishable substance type data. In one example, the controller is configured to obtain preservation gas composition data associated with a perishable substance to be preserved in the compartment and to control the composition of the preservation gas provided by the preservation gas source. In one example, the controller is configured to determine the perishable substance data by a user input or by identifying an inventory control system label of the perishable substance to be preserved.

In another example, the storage 154 is configured to store data relating to one or more target composition levels of the interior of the compartment. In one example, the controller is configured to obtain compartment environment data relating to one or more dynamic characteristics of the interior of the compartment using the one or more sensors and to cause the regulator to regulate the preservation gas transferred from the preservation gas source to the compartment based at least in part on data retrieved from the storage relating to a composition target of the interior of the compartment and the obtained compartment environment data.

In one embodiment, the controller 44 is configured to receive a number of inputs, such as information from sensors 158 (e.g., a temperature sensor, a humidity sensor, and a chemical sensor) and compartment status 160 (e.g., opened or closed drawer status). The controller 44 is configured to control a number of outputs, such as preservation gas (e.g., nitrogen) generation 162, preservation gas control 164 (e.g., nitrogen flow to the compartments), and temperature control 170 (e.g., control of temperature in the compartments and/or control of temperature of preservation gas flowing into a reserve tank).

In one example, the controller 44 is configured to monitor the time since preservation gas has been transferred to the compartment from the preservation gas source and cause a second amount of preservation gas from the preservation gas source to transfer to the interior of the compartment in response to a time period having elapsed since preservation gas was last provided to the compartment from the preservation gas source. In another embodiment, the controller 44 is configured to monitor preservation gas to be delivered to an interior portion of a compartment for a period of time after detecting that the compartment has been moved to a closed position.

### Example 1

### System Having a Plurality of Compartments Having Different Preserving Environments

In one exemplary configuration of a system 10 as seen in FIG. 1, a first compartment may have an environment such as 70° F. and a oxygen concentration of 1% suitable for preserving bread to reduce molding, staling, and kill pests like beetles, weevils, and meal worms. A second compartment may have an environment such as 70° F. and an oxygen concentration of 1% for preserving avocado (fresh, still ripening) to reduce molding and oxidation and to continue ripening. A third compartment may have an environment such as 50° F. and an oxygen concentration of 1% for preserving food such as tomatoes by reducing molding, stop ripening, and temperature related degradation (refrigeration is too cold for tomatoes), cheese by reducing molding, oxidation, and to keep the cheese close to a serving temperature, and ripened avocado by reducing molding, oxidation, and further ripening.

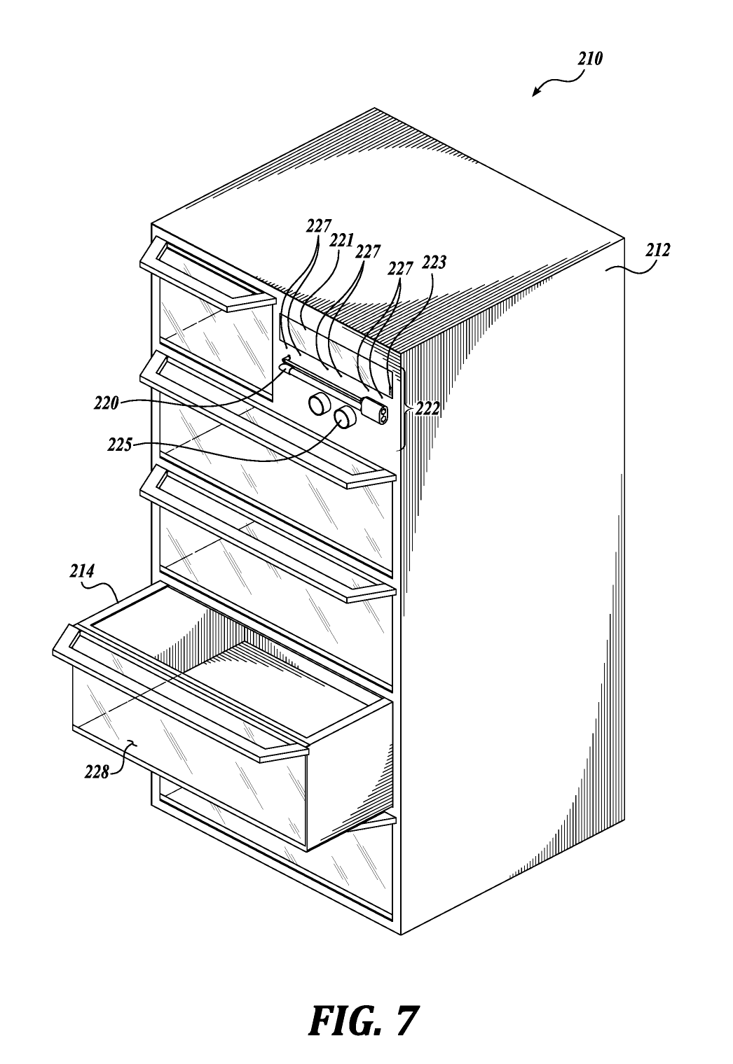

Referring now to FIGS. 7-15, another embodiment of the present disclosure is provided. The embodiment of FIGS. 7-15 is substantially similar to the embodiment of FIGS. 1-6, except for differences regarding the geometric configuration, the preservation gas delivery system, the cooling system, and the control system. Some similar parts of the embodiment in FIGS. 7-15 may be described, where possible, using numerals similar to numerals used in the embodiment of FIGS. 1-6, except in the 200 series.

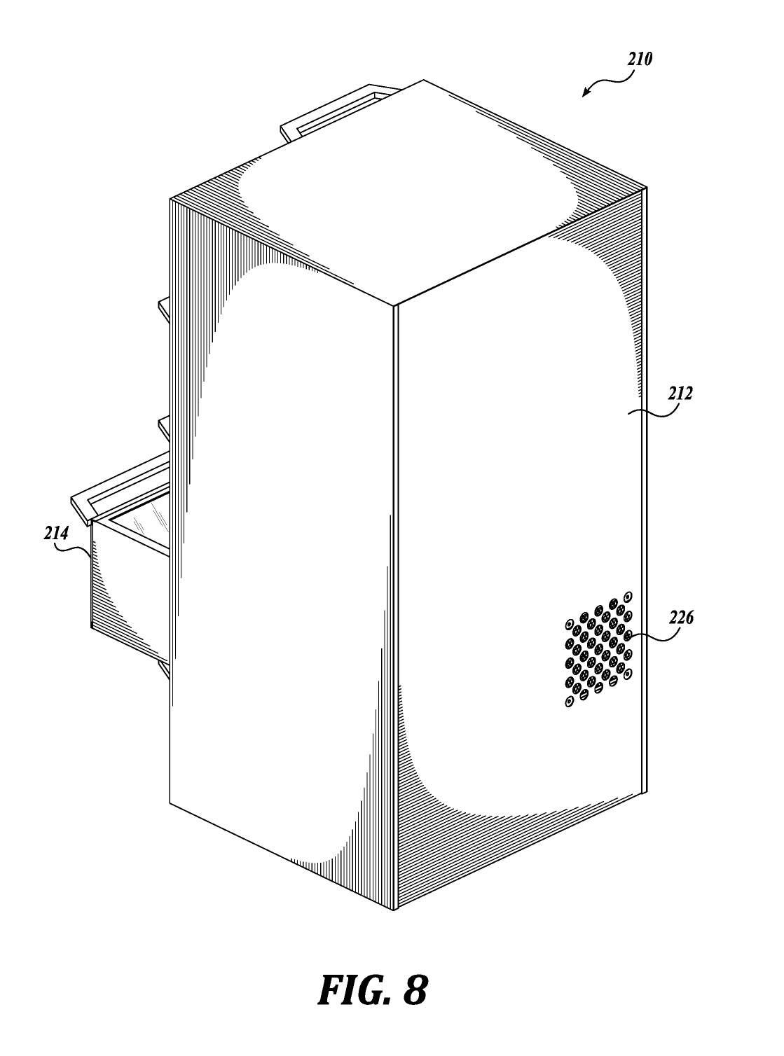

Referring to FIGS. 7 and 8, the system 210 includes a housing 212 having an increased number of compartments 214 compared to the embodiment of FIGS. 1-6. To show how the system is used, some of the compartments are shown in open positions and some in closed positions. In the illustrated embodiment, the system 210 includes a user interface 222 having a user display 221, a data port 223, one or more input devices 225, and a light display 227. The system 210 also includes an external preservation gas delivery system 220.

Other exemplary user interface components may include a keypad, touch-screen, touch sensors, remote Bluetooth connection, IR remote, jog dial, shuttle dial, track ball, slide dial, flip switches, joystick, game controller, other input methods could include image capture devices including traditional cameras, receipt scanners, 3d scanners, IR cameras and fast exposure cameras, etc. Other UI devices could also include microphone or speakers to communicate audibly with the user.

As non-limiting examples, the display 221 can be used to indicate one or more of the following: the set temperature and oxygen conditions in the compartment, the actual temperature of the compartment, the actual oxygen content in the compartment, whether the compartment is open or closed, and whether the external gas delivery system 220 is being used.

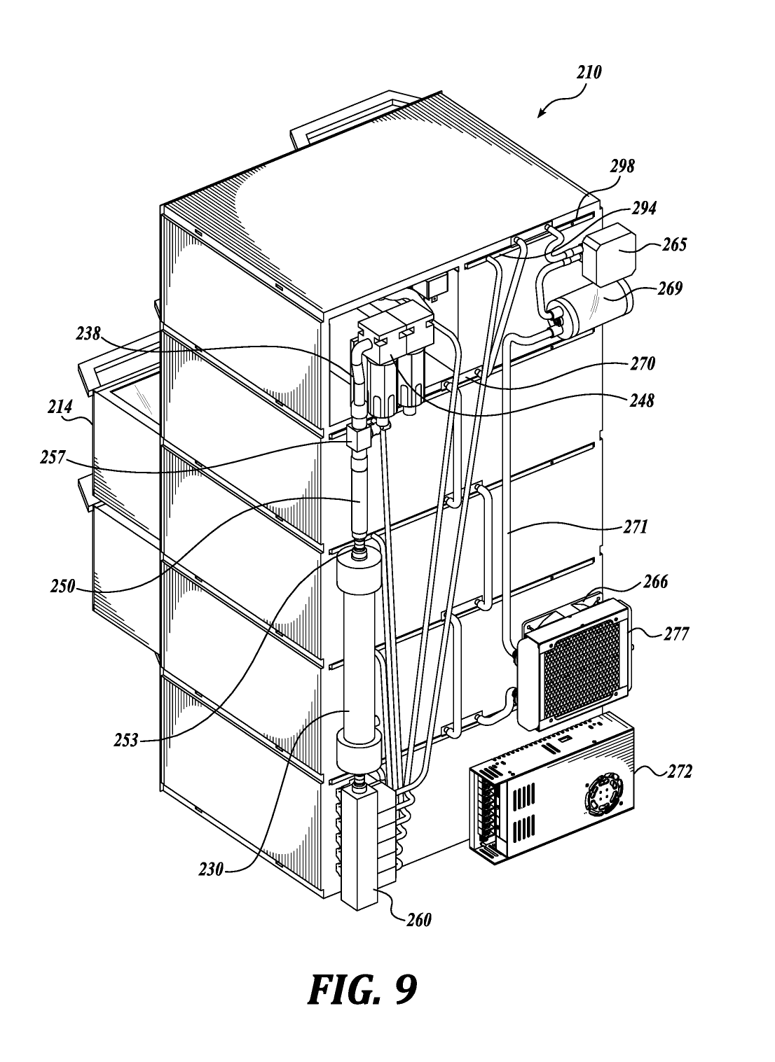

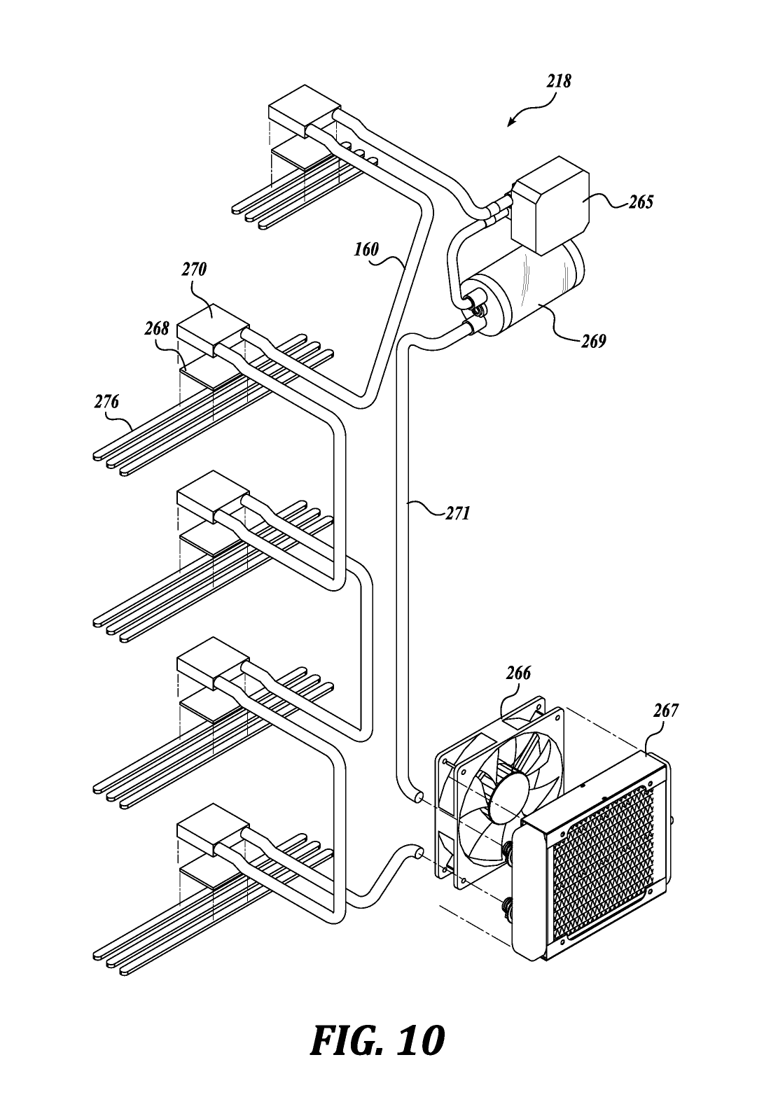

Referring to FIG. 9, a rear view of the system 210 depicted in FIGS. 7 and 8 with the housing 212 removed shows internal components of the system 210 of the illustrated embodiment, to be described in greater detail below. Isolated system views are provided in FIGS. 10-12, discussed below.

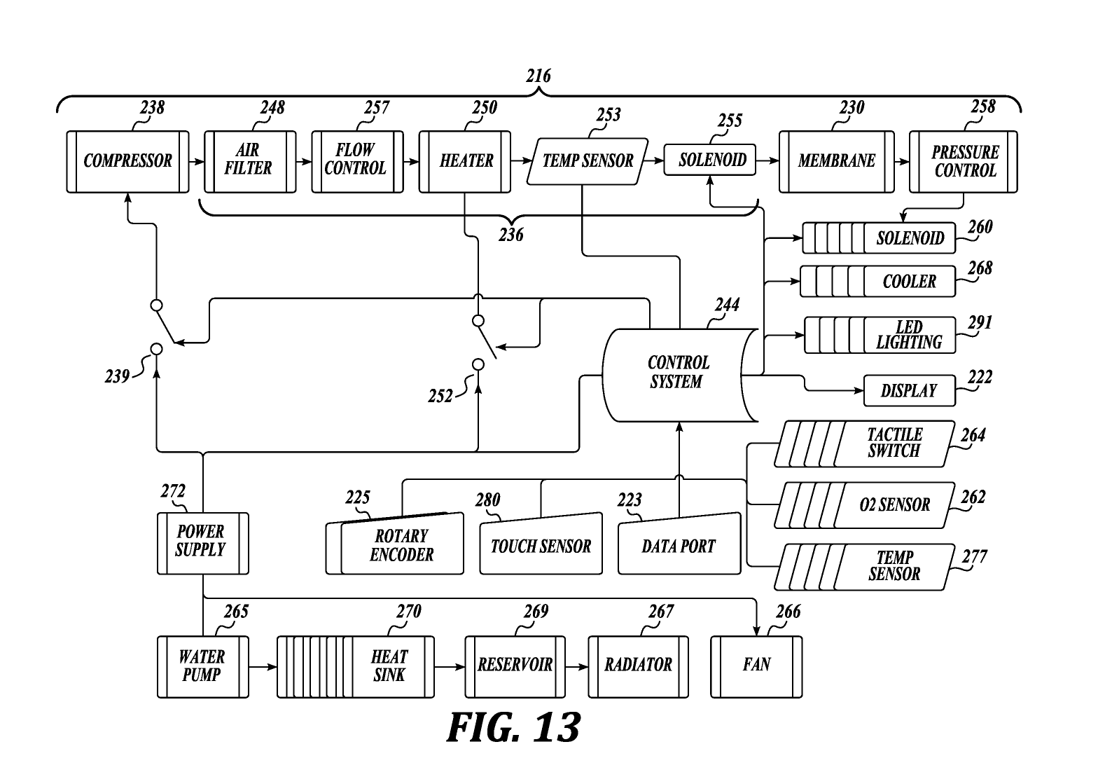

Referring now to FIG. 10, the embodiment of FIGS. 7-15 includes a temperature control system 218 for the compartments 214 of the system 210 (see FIG. 7). FIG. 10 provides an isolated depiction of the temperature control system 218. The control system 244 (see FIG. 13) is configured to control the power provided to thermoelectric coolers 268 based on signals from temperature sensors 277 (see FIG. 13) to maintain a user set temperature in each compartment 214 in the housing 212. One or more thermoelectric coolers 268 are connected to the one or more cold sinks 276 for each compartment 214. A heat sink 270 is thermally connected to the radiator 267 which is cooled by the fan 266. Coolant, such as distilled water or another suitable coolant, can be pumped by a water pump 265 from a reservoir 269 through water pipes 271, heat sinks 270, and the radiator 267 to radiate the heat generated by the thermoelectric coolers 268. The water pump 265 and fan 266 are powered by a main power supply 272 (see FIG. 9 to see the main power supply 272).

The embodiment of FIGS. 7-15 includes a preservation gas delivery system 216 without requiring a preservation gas tank (see preservation gas tank 34 in FIG. 4) for preservation gas delivery storage. Referring to FIG. 13, preservation gas flow rate to the system compartments 214 is controlled upstream of the preservation gas separation membrane 230 and the pressure is controlled downstream of the preservation gas separation membrane 230, as described in greater detail below. Such a configuration provides for on-demand preservation gas delivery.

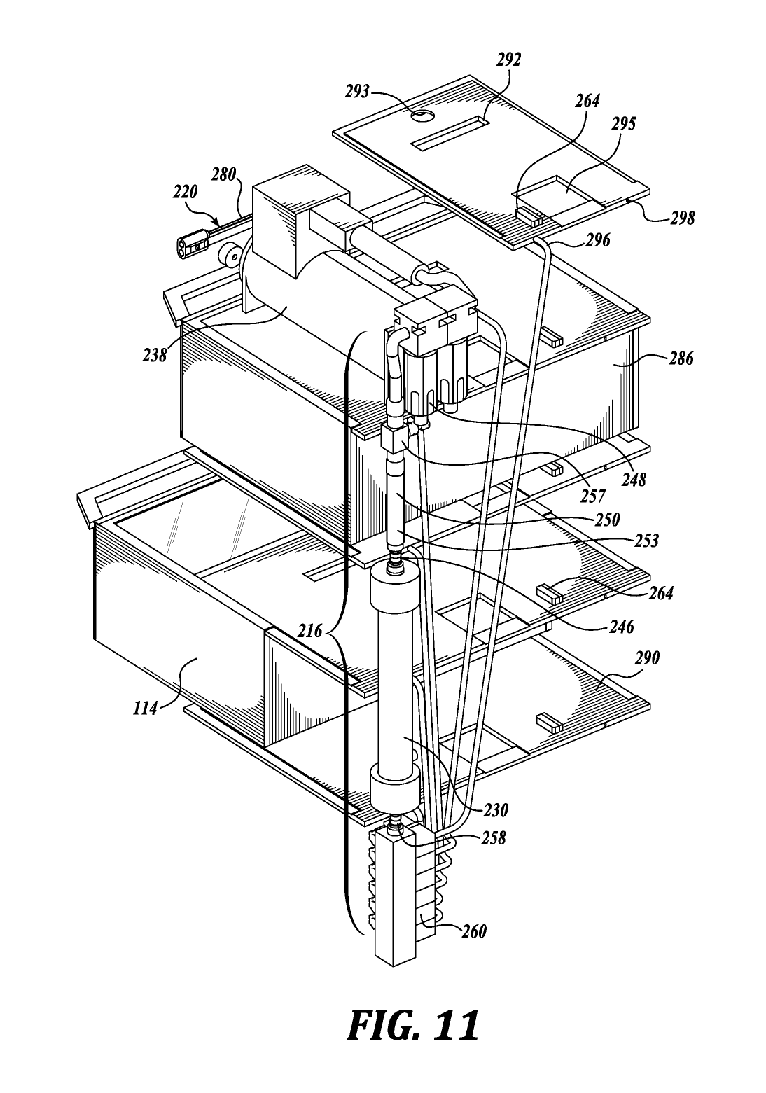

Referring to the rear view of the system 210 in FIG. 9 and the isolated depiction of the preservation gas system in FIG. 11, the preservation gas delivery system 216 includes a compressor 238 configured to push ambient air into the preservation gas separation membrane 230. In one embodiment, the compressor 238 is activated by a compressor support system in the control system 244. The compressor support system may, for example, include as a compressor relay 239 activated by the control system 244 (control system 244 is shown in the operational schematic of FIG. 13).

Like the embodiment of FIGS. 1-6, the preservation gas delivery system 216 in the embodiment of FIGS. 7-15 includes an air control system 236 configured to control one or more of temperature, pressure, filtering, and/or flow rate of the ambient air though the preservation gas separation membrane 230. In one embodiment, the air control system 236 includes an air filter 248 configured to filter the compressed air (e.g., remove particles, contaminants, and moisture). In another embodiment temperature is controlled by a heater 250 and heater support systems, such as a heater relay 252. A temperature sensor 253 provides feedback to the control system 244 to provide the heater relay with an appropriate signal and to provide control to the cold air exit solenoid 356 for delivering gas to the gas separation membrane 230.

In yet another embodiment flow rate and pressure are controlled either by a flow regulator 257 or a pressure regulator 258 or both. In the illustrated embodiment, flow control of air to the preservation gas membrane 230 (e.g., by a flow regulator 257 or a pressure regulator 258 or both) is downstream of the compressor 238.

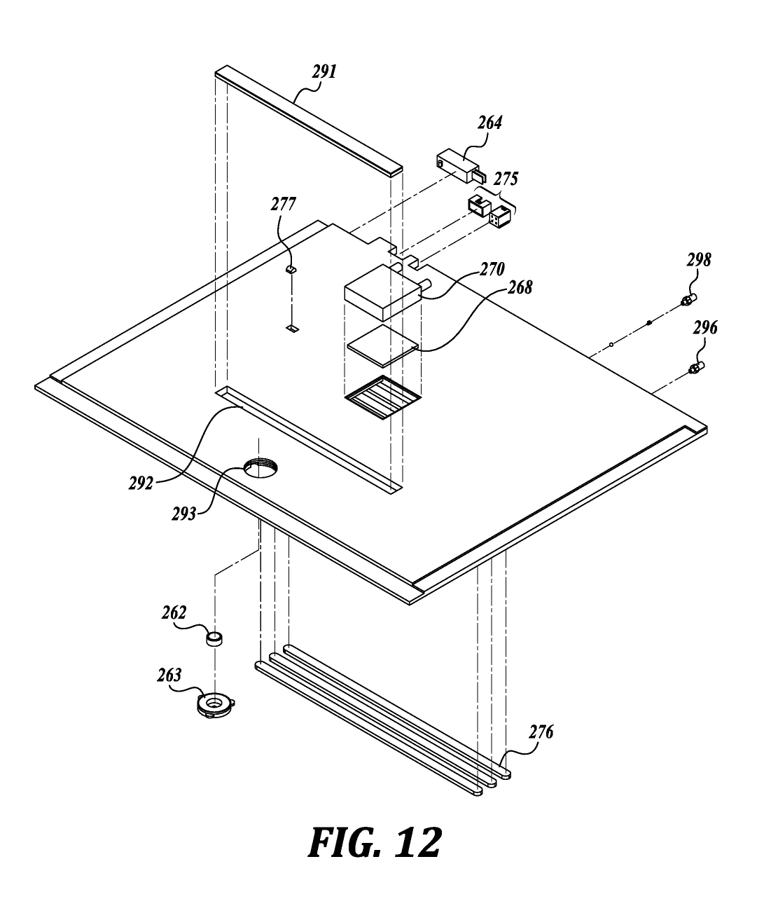

In the depicted embodiment, the control system 244 is configured to direct pressurized preservation gas from the preservation gas generation system to the compartments 214 via solenoids 260. In one example, the controller 244 directs pressurized preservation gas into the compartments 214 based on readings from independent sensors 262 within each compartment 214. The sensor 262 may be contained in a housing 263 (see FIG. 12).

The sensors 262 may be gas composition sensors, for example, oxygen sensors, nitrogen sensors, carbon dioxide sensors. Carbon dioxide sensors, in addition to gas composition information, may provide bacterial activity information.

The solenoids 260 are operated by the control system 244 which reads the status of compartments 214 in the housing 210, through a series of tactile switches 264 or other sensors to ensure that compartments 214 are not vented with preservation gas when in an open position and to ensure that compartments are filled appropriately in response to the compartments 214 having been moved from an open position to a closed position. In one embodiment, preservation gas may be directed to fill compartments based on a compartment open status based on a reading from a tactile switch 264 and a timing protocol for filling the compartment.

An isolated depiction of one embodiment of a sealing compartment system for a compartment 214 moving from an open position to a closed position is illustrated in FIG. 11. While the compartment 214 depicted in FIG. 11 is in the form of a drawer, the compartment may take other forms, such as a cabinet with a swinging door or doors.

Still referring to the illustrated embodiment of FIG. 11 and also referring to the embodiment of FIG. 12, the compartment 214 includes various components for feedback and control. In the illustrated embodiments, the components are mainly located in the top portion 290 of the compartment 214. However, components may be configured to be in other locations in the compartments 214. In FIGS. 11 and 12, the top portion 290 includes a recess 292 to receive compartment lighting 291 (see FIG. 12), a recess 293 to receive a gas composition sensor 262 (see FIG. 12), such as an oxygen sensor, a gas outlet 298 with one way valve, and a gas inlet 296 from the preservation gas delivery system 216.

In the illustrated embodiment of FIGS. 11 and 12, the top portion 290 of the compartment 214 further includes a recess 295 for receiving the thermoelectric coolers 268, heat sinks 270, and cold sinks 276, all used in the system for adjusting the temperature of the compartment 214. The compartment 214 further includes a temperature sensor 277 for detecting temperature within the compartment and activating the temperature control system 218. The compartment 214 also includes a tactile switch 264. Electrical connections 275 provide power and sensor connections to the components in the sealing top portion 290 of the compartment 214.

Like in the previously described embodiment, the body portion 288 of the compartment 214 is suspended from the top portion 90 to create a seal and reduce gas exchange between the compartment 214 and the external environment when the compartment 214 is in its closed position.

The gas inlet 296 allows preservation gas to enter the compartment from the preservation gas sources (e.g., from the preservation gas generation system when a solenoid 260 is actuated). Gas is permitted to pass from the interior of the compartment 214 through the exit outlet valve 298 when forced out by preservation gas introduced through the gas inlet 296. In other embodiments, doors or other sealing mechanisms may be used.

Additionally in another embodiment the depicted in FIG. 11 an external gas delivery system 220 (see also FIG. 7) provides for the delivery of preservation gas to an external source. Referring to FIG. 11, the external gas delivery system 220 includes a hose 280 having a sensor unit capable of detecting temperature and/or gas composition of a remote source environment. The hose 280 and sensor system allow for filling remote compartments not part of the housing 210. The hose 280 may include a magnetic sensor to indicate whether it is attached to the housing or in use for external applications.

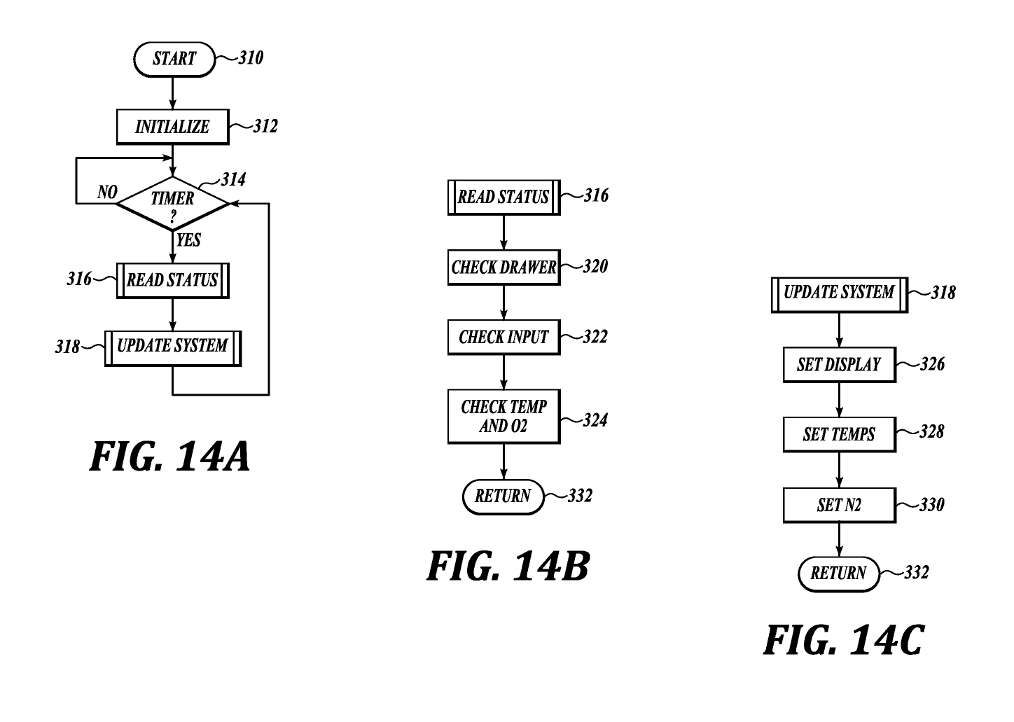

The control system 244 for the embodiment of FIGS. 7-15 will now be described in greater detail. In one embodiment, the control system 244 is capable of executing a program to perform a method depicted in FIGS. 14A, 14B, and 14C. The method depicted in FIGS. 14A, 14B, and 14C includes a main routine 310 and two subroutines: read status 316, and update systems 318.

The main routine 310 initializes 312 I/O variables and counters. In one embodiment, the initialization 312 occurs on power up before entering a control loop. The control loop begins by waiting 314 for a timing signal to ensure consistent execution time. Once the timing signal is received, the controller reads 316 system status. In one embodiment, reading 316 the system status includes consulting tactile switches 264 to determine a change in compartment status (e.g., a change from an open position to a closed position). In another embodiment reading 316 the system includes monitoring inputs such as changes to the rotary input devices 225, and for checking for new inventory control system label information through a data port 223. In yet another embodiment is also includes checking the temperature 277 and oxygen sensors 262 for each compartment 214.

The control system executes the update systems subroutine 318. In one embodiment the update systems subroutine 318 first consults variables updated in the read status subroutine 316 to set the I/O for the display 222 and activates lighting 291 in the corresponding compartments. In another embodiment the control system determines the signal controlling the thermoelectric coolers 268. In yet another embodiment the control system determines if more preservation gas needs to be generated 330 and sets the compressor relay 239, heater relay 252, cold air exit solenoid 255, and compartment solenoid 260 signals accordingly.

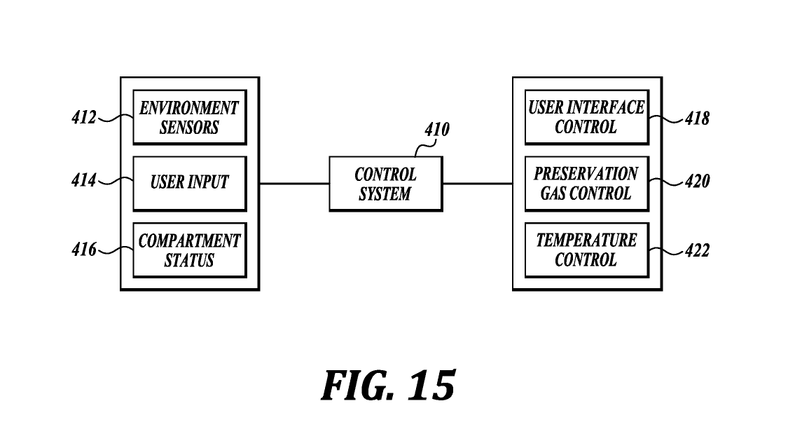

An example control system 244 capable of performing the method depicted in FIGS. 14A, 14B, and 14C is depicted in FIG. 15. In one example, the control system 410 is configured to store preservation gas composition data and corresponding perishable substance type data. In one example, the control system 410 is configured to obtain preservation gas composition data associated with a perishable substance to be preserved in the compartment and to control the concentration of the preservation gas provided by the preservation gas source 420. In one example, the control system is configured to determine the perishable substance data by a user input 414 or by identifying an inventory control system label of the perishable substance to be preserved though data port 223.

In another example, the control system 410 is configured to store data relating to one or more target composition levels of the interior of the compartment. In one example, the control system is configured to obtain compartment environment data relating to one or more dynamic characteristics of the interior of the compartment using the one or more environmental sensors 412 the control systems determines the amount of preservation gas transferred from the preservation gas source to the compartment based at least in part on data retrieved by or stored on the control system relating to a composition target of the interior of the compartment and the obtained compartment environment data.

In one embodiment, the controller 410 is configured to receive a number of inputs, such as information from environmental sensors 412 (e.g., a temperature sensor and/or a chemical composition sensor) and compartment status 416 (e.g., drawer status determined from switch). The controller 410 is configured to control a number of outputs, such as preservation gas (e.g., nitrogen) control 420, (e.g., nitrogen flow to the compartments), and temperature control 422 (e.g., control of temperature in the compartments).

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the disclosure in which an exclusive property or privilege is claimed are defined as follows:

1. A system for preserving perishable substances, the system comprising:
a first compartment and a second compartment, wherein each of the first and second compartments has an interior portion having a volumetric capacity of less than or equal to about 35 cubic feet;
a preservation gas delivery system; and
a control system configured to deliver preservation gas from the preservation gas source separately to the interior portions of each of the first and second compartments such that the interior portions of each of the first and second compartments has a gaseous environment with an oxygen level less than about 20% when the first and second compartments are in a closed position, wherein the oxygen level in the first compartment is different from the oxygen level in the second compartment.

2. The system of claim 1, further comprising a housing configured to contain the first and second compartments, the preservation gas delivery system, and the control system.

3. The system of claim 1, further comprising a temperature control system configured to selectively change the temperature within at least one of the first and second compartments.

4. The system of claim 1, further comprising an input device configured to receive an input indicative of a substance to be contained in one of the first and second compartments or by an input indicative of a storage method to be executed.

5. The system of claim 4, wherein the control system is further configured to deliver the preservation gas to the one of the first and second compartments based on the substance to be contained in the one of the first and second compartments or the storage method to be executed.

6. The system of claim 4, wherein the input device is configured to receive the input by at least one of receiving a user-entered input or reading an inventory tracking system label.

7. The system of claim 1, wherein at least one of the first and second compartments includes a transparent portion configured to make at least a portion of the interior portion viewable from an external viewer when the one of the first and second compartments is in the closed position.

8. The system of claim 1, wherein the preservation gas delivery system includes a preservation gas generation system configured to provide a preservation gas to at least one of the first and second compartments.

9. The system of claim 8, wherein the preservation gas generation system includes at least one of a preservation gas separation membrane configured to separate a preservation gas from ambient air, a preservation gas generator configured to generate the preservation gas from chemical or physical reactions, and a preservation gas supply tank.

10. The system of claim 8, wherein the preservation gas generation system includes a preservation gas separation membrane, and wherein the preservation gas generation system further includes an air control system configured to control one or more of temperature, pressure, filtering, and flow rate of the ambient air to the preservation gas separation membrane.

11. The system of claim 8, wherein the preservation gas generation system comprises one or more of a nitrogen membrane configured to separate nitrogen from the ambient air, an argon membrane configured to separate argon from the ambient air, or a carbon dioxide generator configured to generate carbon dioxide from a chemical or physical reaction.

12. The system of claim 1, further comprising at least one sensor configured to generate a signal indicative of at least one characteristic within the interior portion of the compartment.

13. The system of claim 1, wherein the preservation gas delivery system is configurable to deliver preservation gas to an external source.

14. A system for preserving perishable substances, the system comprising:
a compartment having an interior portion;
a preservation gas generation system configured to provide a preservation gas, the preservation gas generation system comprising at least one of a preservation gas separation membrane configured to separate a preservation gas from ambient air or a preservation gas generator configured to generate the preservation gas from chemical or physical reactions;
a control system configured to selectively deliver the preservation gas from the preservation gas generation system to the interior portion of the compartment such that the interior portion of the compartment has a gaseous environment with an oxygen level less than about 20% when the compartment is in a closed position; and
a housing configured to contain the compartment, the preservation gas separation membrane, and the control system.

15. The system of claim 14, wherein the preservation gas generation system comprises one or more of a nitrogen membrane configured to separate nitrogen from the ambient air, an argon membrane configured to separate argon from the ambient air, or a carbon dioxide generator configured to generate carbon dioxide from a chemical or physical reaction.

16. The system of claim 14, further comprising a preservation gas tank configured to store the preservation gas separated from the ambient air by the preservation gas separation membrane, wherein the control system is configured to selectively deliver the separated preservation gas from the preservation gas tank to the interior portion of the compartment.

17. The system of claim 14, further comprising an air control system configured to control one or more of temperature, pressure, filtering, and flow rate of the ambient air to the preservation gas separation membrane.

18. The system of claim 14, further comprising at least one sensor configured to generate a signal indicative of at least one characteristic within the interior portion of the compartment.

19. The system of claim 14, wherein the control system is configured to deliver the separated preservation gas to the interior portion of the compartment based on the at least one characteristic within the interior portion of the compartment.

20. The system of claim 19, wherein at least one sensor comprises one or more of a temperature sensor configured to generate a signal indicative of temperature within the interior portion of the compartment, a humidity sensor configured to generate a signal indicative of humidity within the interior portion of the compartment, or a chemical sensor configured to generate a signal indicative of a chemical composition within the interior portion of the compartment.

21. The system of claim 14, wherein the housing has a volumetric capacity of less than or equal to about 50 cubic feet.

22. The system of claim 14, wherein the preservation gas delivery system is configurable to deliver preservation gas to an external source.

23. A method of maintaining an environment for preserving perishable substances within a compartment, wherein the compartment has as interior portion, and wherein the compartment is capable of being moved between an open position and a closed position, the method comprising:
detecting that the compartment is in a closed position; and
delivering a preservation gas to the interior portion of the compartment in response to detecting that the compartment has been moved to the closed position, wherein delivering the preservation gas causes an oxygen content of a gaseous environment in the interior portion of the compartment to be less than about 20%.

24. The method of claim 23, wherein the compartment has been moved from an open position to a closed position.

25. The method of claim 23, wherein delivering the preservation gas comprises delivering the preservation gas to the interior portion of the compartment for a period of time after detecting that the compartment has been moved to the closed position.

26. The method of claim 23, wherein delivering the preservation gas comprises delivering the preservation gas to the interior portion of the compartment in response to feedback from at least one sensing device within the compartment.

27. The method of claim 26, wherein at least one sensing device comprises one or more of a temperature sensor configured to generate a signal indicative of temperature within the interior portion of the compartment, a humidity sensor configured to generate a signal indicative of humidity within the interior portion of the compartment, or a chemical sensor configured to generate a signal indicative of a chemical composition within the interior portion of the compartment.

28. The method of claim 23, further comprising separating the preservation gas from ambient air using a preservation gas separation membrane.

29. The method of claim 26, further comprising controlling one or more of a temperature, a pressure, filtering, or a flow rate of the ambient air to the preservation gas separation membrane.

30. The method of claim 23, wherein the interior portion of the compartment has a volumetric capacity of less than or equal to about 5 cubic feet.
